(19) United States
(12) Patent Application Publication
(10) Pub. No.: US 2015/0161671 A1
(43) Pub. Date: Jun. 11, 2015

(54) SYSTEM FOR HARNESSING USER BEHAVIOR ASSOCIATED WITH A SERVER-BASED RESOURCE

(71) Applicant: Action Exchange, Inc., New York, NY (US)

(72) Inventor: Edwin Watkeys, New York, NY (US)

(73) Assignee: Action Exchange, Inc., New York, NY (US)

(21) Appl. No.: 14/099,629

(22) Filed: Dec. 6, 2013

(51) Int. Cl. G06Q 30/02; H04L 29/08

(52) U.S. Cl. CPC G06Q 30/0269; H04L 67/22

(57) ABSTRACT

A system and method are disclosed for harnessing user behavior. In an example, the system may include means for receiving event data messages from client devices, wherein an application is associated with an advertiser having a product catalog of products available for purchase; means for extracting a product identifier, wherein each of the product identifiers is associated with a product; means for searching a database using the product identifiers to determine whether an existing product profile has been created; means for generating and populating a new product profile with information derived from a corresponding event data message, for each of the product identifiers for which no existing product profile has been created, wherein the database stores the existing and new product profiles as a second product catalog that comprises at least a subset of a product catalog of the advertiser.

### 1. FIELD

This invention relates to the Internet. In particular, this invention relates to a system for harnessing user behavior associated with a server-based resource, such as an ecommerce site, or subscription-based content site, or a mobile application depending on such a resource.

### 2. DISCUSSION OF THE RELATED ART

Promoting of products and services is important to commercial entities. The internet has opened up a virtually limitless supply of advertising opportunities, particularly in the mobile device context. Advertisers, however, want to ensure that they are receiving good value for their advertising dollar. Data mining techniques are used to target advertisements, but there is room for improvement in these techniques

### BRIEF SUMMARY

The example embodiments relate, in one aspect, to a system for harnessing user behavior. In an example, the system may include means for receiving a plurality of event data messages from a plurality of client devices, wherein the event data messages are generated in response to a user of each of the client devices utilizing an application, wherein the application is associated with an advertiser having a product catalog of products available for purchase via the application; means for extracting a product identifier from each of the event data messages, wherein each of the product identifiers is associated with a product available for purchase via the application; means for searching a database using each of the product identifiers to determine whether an existing product profile has been created for the corresponding product identifier; means for generating a new product profile in the database and populating at least one attribute field in the new product profile with information derived from a corresponding event data message, for each of the product identifiers for which no existing product profile has been created, wherein the database stores the existing and new product profiles as a second product catalog that comprises at least a subset of the product catalog of the advertiser.

Other systems, methods, features, and advantages of the present disclosure will be or will become apparent to one with skill in the art upon examination of the following figures and detailed description. All such additional systems, methods, features, and advantages are included within this description, are within the scope of the disclosure, and are protected by the accompanying claims. Accordingly, the present disclosure is not restricted except in light of the attached claims and their equivalents.

### BRIEF DESCRIPTION OF THE FIGURES

For a better understanding of the present disclosure, non-limiting and non-exhaustive embodiments are described in reference to the following drawings. In the drawings, like reference numerals refer to like parts through all the various figures unless otherwise specified.

FIG. 1 illustrates a system for tracking user behavior in accordance with example embodiments.

FIG. 2 illustrates examples of generating and processing event data in accordance with example embodiments.

FIGS. 3A, 3B, 3C, and 3D collectively illustrate example user interface displays of a client device in accordance with example embodiments.

FIG. 4 illustrates example event data messages in accordance with example embodiments.

FIG. 5 illustrates an example of a passively collected product catalog in accordance with example embodiments.

FIG. 6 illustrates an example user profile table in accordance with example embodiments.

FIGS. 7A, 7B, 7C, 8A and 8B illustrate example user interface displays of a client device in accordance with example embodiments.

FIG. 9 illustrates an example dashboard interface in accordance with example embodiments.

FIG. 10 illustrates a flow chart of a method for advertisement retargeting in accordance with example embodiments.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. Accordingly, the present disclosure and its components may take the form of an entirely hardware embodiment, an entirely software embodiment or an embodiment combining software and hardware aspects. The following detailed description is, therefore, not to be taken in a limiting sense.

Product and service promotion can directly impact an advertiser's bottom line. In some instances, an advertiser may electronically store a catalog and retain a promoter to algorithmically promote a product/service (hereafter “product”) from the catalog individually or in sets. The catalog may include images, product descriptions, geographic service regions, product attribute data, and the like describing products available for purchase from the advertiser. The problem of the promoter ingesting the catalog in its entirety and its updates from the advertiser is non-trivial for both the advertiser and the promoter.

One method to ingest a catalog is the implementation of a data feed. The advertiser may communicate its catalog and catalog updates via a data feed to the promoter for storage of a mirrored copy of the catalog. The mirrored copy may be the exact same as or a subset of the advertiser's version. The promoter selects which products to advertise from the mirrored catalog. Both push and pull product catalog feeds become more efficient once they have been established. However, there may still be significant problems even if a catalog remains in a fairly steady state (e.g., is infrequently updated). Among other potential problems, a promoter's mirrored copy may lag behind even minor changes, thus, diminishing some of the usefulness. Moreover, even if mirrored data is well synchronized with the advertiser's catalog, mirroring all of the data from the catalog may be a waste of resources inasmuch as some products fail to attract any buyers or viewers. The advertiser thus consumes resources building data feed infrastructure that might be used to otherwise improve its products. The effort to build push or pull feed infrastructure is also undertaken speculatively—or more speculatively than, at the very least—other “lower hanging fruit” on which an advertiser could choose to expend its scarce resources. Among other potential issues, a significant amount of bandwidth is expended transferring the initial catalog to the promoter. The advertiser would also disadvantageously have to continuously monitor users' interactions with and purchases using a client application on their mobile device, and communicate such information to the promoter via the data feed. Thus, making the continual feed, storage, and updating of these irrelevant products a waste.

Further, the volume of data transferred via the data feed may significantly burden the promoter. In some instances, the advertiser may potentially communicate thousands—or millions—of messages to the promoter via the data feed where fewer may have sufficed. The burden of managing this data torrent falls on the promoter. These issues are magnified for promoters promoting products for multiple advertisers each having at least one if not more product catalogs.

Other problems may arise even before catalog ingestion. Some advertisers may have a unique combination of product catalog, product catalog schema, database software, and other infrastructure that may require the promoter and advertiser to spend significant resources to extract, transmit, and ingest the product catalog in the first instance. While promoters may be eager to do this integration work, advertisers often avoid providing unfettered catalog access even to trusted third parties. As such, there is little that a would-be promoter can do to assist a potential advertiser in this effort.

The example embodiments remove the need for advertisers to implement a data feed to directly transfer data from the advertiser to the promoter, and instead promoters passively collect data from users of an advertiser's software application. In accordance with example embodiments, an advertiser may develop a software application (“app”) that a user can download onto their computer or mobile device. The app may provide a convenient interface allowing the customer to browser products available for purchase from the advertiser.

The promoter may incorporate noting code into the app that periodically pushes to the promoter data identifying products in the advertiser's product catalog that have been viewed by a user. Pushing data in this manner may eliminate the need for the advertiser itself to implement a data feed to directly communicate catalog data to the promoter. This data transfer may be insignificant to the user considering that the additional transmitted data by the client device does not place a significant burden on the CPU, battery life, or network connections. The additional effort to include product information (e.g. product name, image URL, price, etc.) in such transmissions is minimal and incremental. The promoter is thus able to passively collect data from the user's client device, and not the advertiser, for use in an algorithmic marketing service. Advantageously, the advertiser is not required to implement data feed infrastructure.

The example embodiments provide further advantages by processing user behavior data for advertisement retargeting. Retargeting (also known as remarketing) is the practice of presenting marketing materials to consumers based on each individual's previous behavior. One retargeting example is to present a banner ad featuring a product that a user previously placed in an electronic shopping cart but subsequently did not purchase. Retargeting may be based on two concepts: 1) people are far more likely to purchase products they have previously expressed interest in and 2) people are easily distracted or dissuaded from making purchases. Therefore, personalized marketing materials featuring products in which a user previously expressed interest are effective at prompting or persuading the user to complete the purchase.

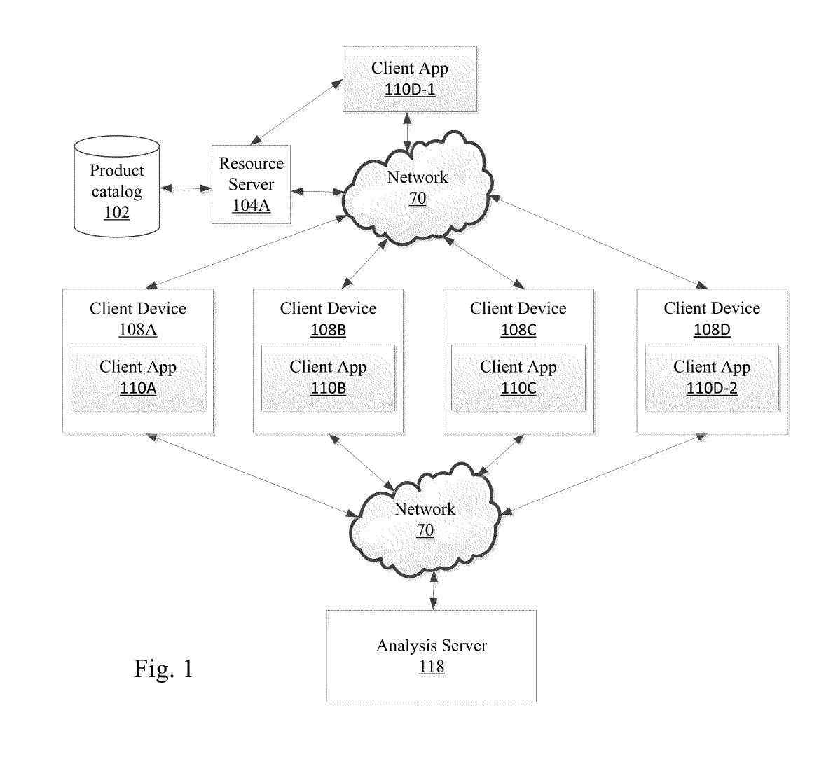

FIG. 1 illustrates a system for tracking user behavior in accordance with example embodiments. In an example, an advertiser may implement a resource server 104 to provide access to its product catalog database 102 and to an app 110 for download by client devices 108A-D via network 70. Only a single resource server 104 is shown, however, each advertiser may have its own resource server. In an example, a client device 108 may be a smart phone that downloads app 110 (e.g., iOS app, HTML web app, Android app, desktop app, etc.), which provides a web-based interface permitting the user to view and purchase products from the advertiser. Client device 108 may locally store the app 110 (e.g., app 110D-1) or it may be at least partially remotely stored at a network location (e.g., app 110D-2) and accessible by the client device 108D via network 70.

The app 110 may permit client devices 108 to access product catalog database 102 listing products and/or services available for purchase from the advertiser. The app 110 may include may include one or more functions that the user can initiate for purposes of navigation through the product catalog 102 and making purchases. Example functions may include launching the app, registering the app, using the app to browse a product category, searching for a particular product, viewing a particular product, adding a particular product to a cart, purchasing a particular product, and designating in-app preferences, such as the users preferred bricks-and-mortar location for the advertiser.

When a function is initiated, the app 110 may generate a value for one or more attributes. Example attributes may include product type, product color, geographic location of the user, geographic location of a viewed service, product price, number of views of a product, number of times a product was moved to checkout and not purchased, and the like. Client device 108 may generate event data by monitoring which functions of the app 110 the user initiates and values of any attributes associated with the initiated functions. At periodic time intervals, app 110 may cause client device 108 to communicate the event data to the analysis server 118 for processing.

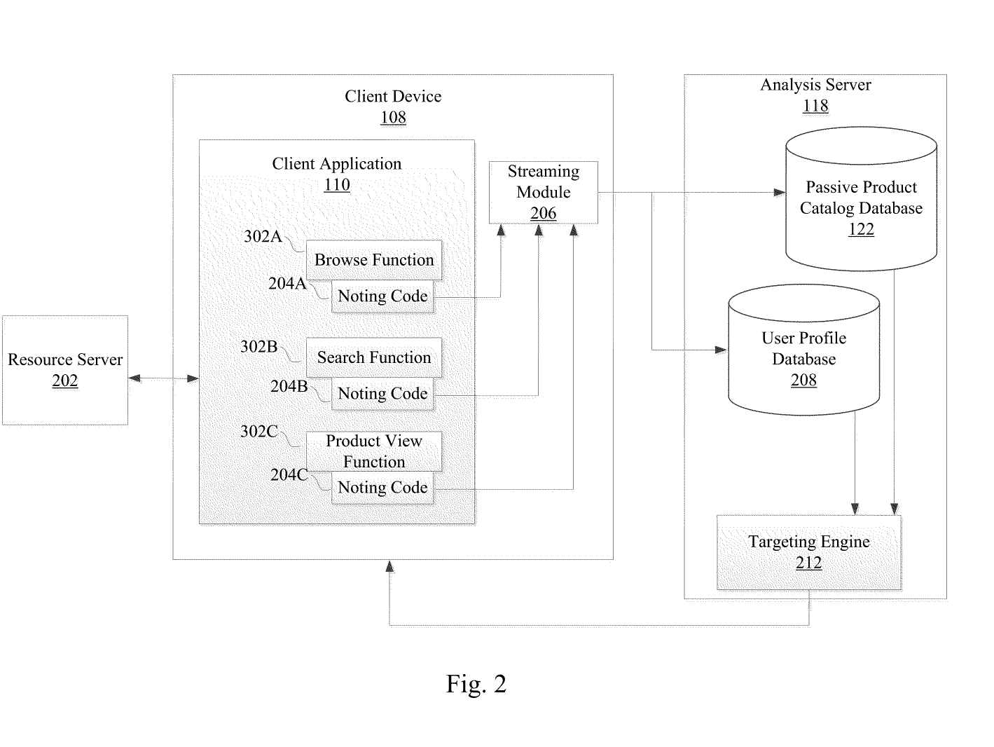

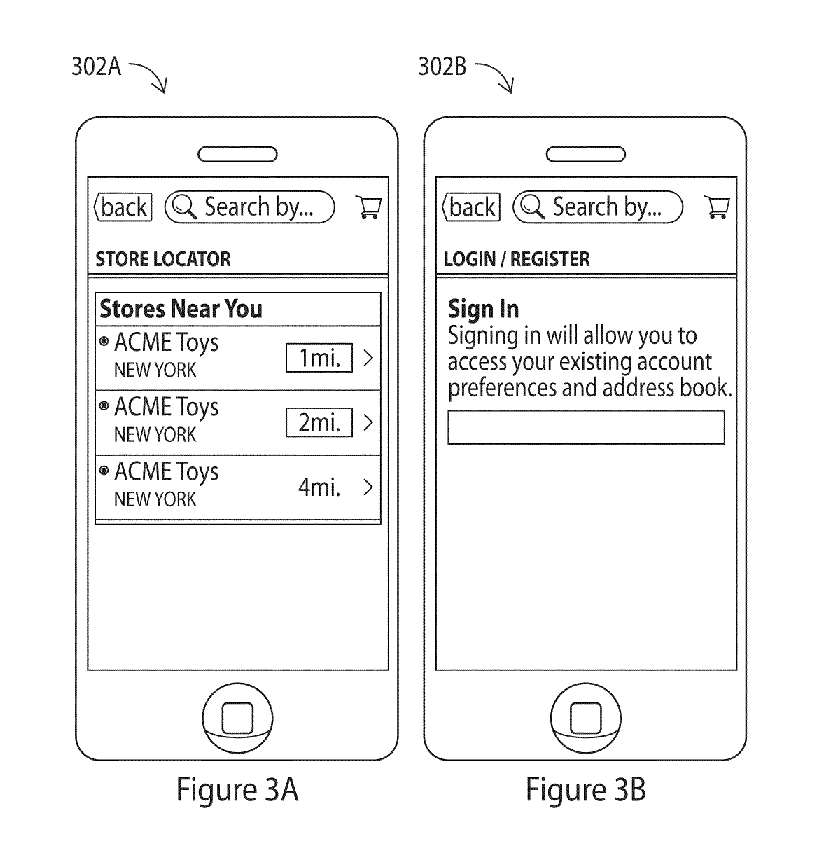

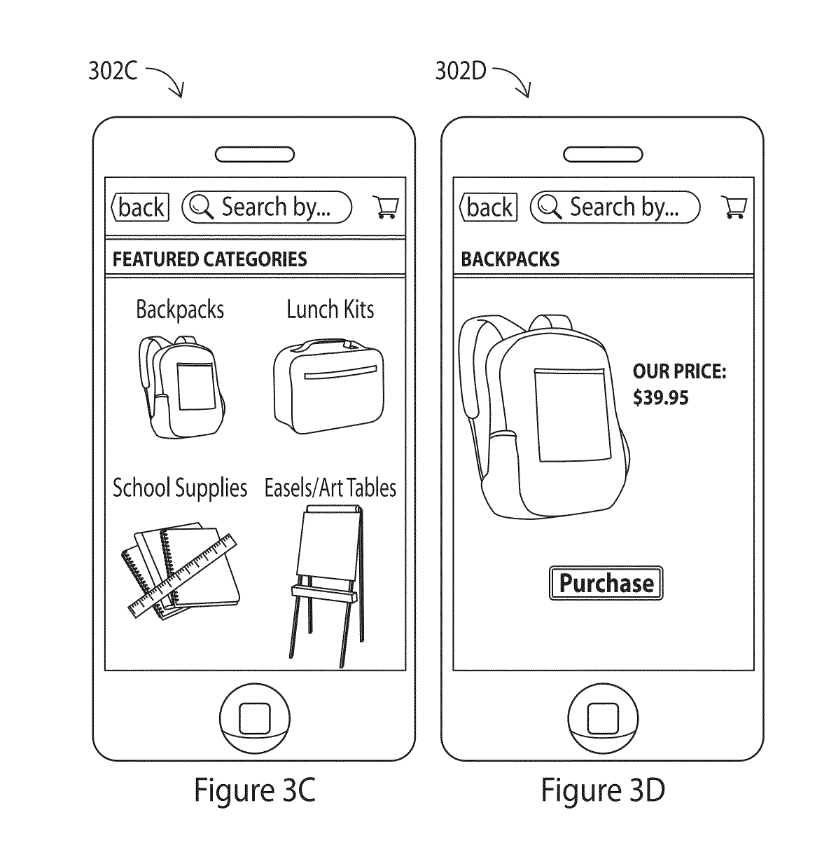

FIG. 2 illustrates additional detail on generating and processing user behavior data, and FIGS. 3A-D illustrate example displays in a user interface of client device 108, in accordance with example embodiments. With reference to FIG. 2, a user may download app 110 from resource server 202 and launch the app. The app 110 may enable the user to browse through, search for, view, and potentially purchase products and/or services available in product catalog 102 via client device 110, and may have one or more additional functions that the user can initiate. FIGS. 3A-D illustrate displays 302A-D for an example graphical user interface of app 110. Display 302A corresponds to a store locator function of the app, display 302B corresponds to a sign-in page function, display 302C corresponds to a featured categories function, and so forth. Optionally, during each launch, app 110 may communicate with resource server 202 to obtain computer code updating the functions and data on products available for purchase.

In some examples, noting code may be added to app 110 to note (e.g., monitor) events when a user initiates at least selected functions of the app. The noting code—which may contain a designation for the associated function—captures attributes associated with the function and sends it on an ad hoc basis to a local streaming module. For example, noting code 204A-C may be embedded within each function to generate user behavior data indicating whether a particular function has been initiated, and the values of any attributes for the initiated function. Client device 108 may download the app 110 with the noting code 204A-C already embedded therein, or may separately download the noting code 204A-C from the analysis server 118 for integration with the app 110. After the noting code 204 is integrated, client device 110 may record event data resulting from app 110 usage.

The types of event data recorded may depend on what types of information is of interest to a promoter and/or advertiser. Example types of event data may include: when a user launches the app 110, when a user sign-in dialog is displayed, when sign-in is attempted, when a sign-up page is loaded, success or failure of sign-in, each time a signed-in user interacts with app 110, either after signing in for the first time or launching the app 100 after providing credentials, tag (e.g., SKU or other product identifier) of a product a user viewed, added to, or removed from a virtual shopping cart, the user shared the product (e.g., via social media), product added to or removed from the user's wish list, a number of times a user has viewed a particular product, the user deep linked to a product or category, the user viewed or deep linked to a tag, the user viewed a category, a user's search activity (e.g., record a query string of search terms only when a user pauses typing), category of a viewed product, what products were purchased using the app, and what time and how frequently the app 110 is launched.

Event data may also include general information about the user and the client device, including: a user identifier (e.g., in hashed form if it represents personally-identifiable information) that uniquely identifies a particular user to permit marketing across multiple devices, type of membership (e.g., trial, basic, premium, Facebook® user, etc.), advertiser identifier (e.g., Apple® IDFA), current geographic location of the user (e.g., if granted permission by the user), attributes pertaining to the user (e.g., logged in, quick checkout, is a subscriber, etc.), past user traits (e.g., user is no longer a subscriber), a version of a software development kit (SDK), device information (e.g., MAC address or other identifier), and other client apps the user has downloaded or subscribed. Examples of a user identifier may include a consumer identifier, a Google Android® ID, an Apple® ID, a MAC address, and the like. The event data may be stored in the clear or as a hash of clear text.

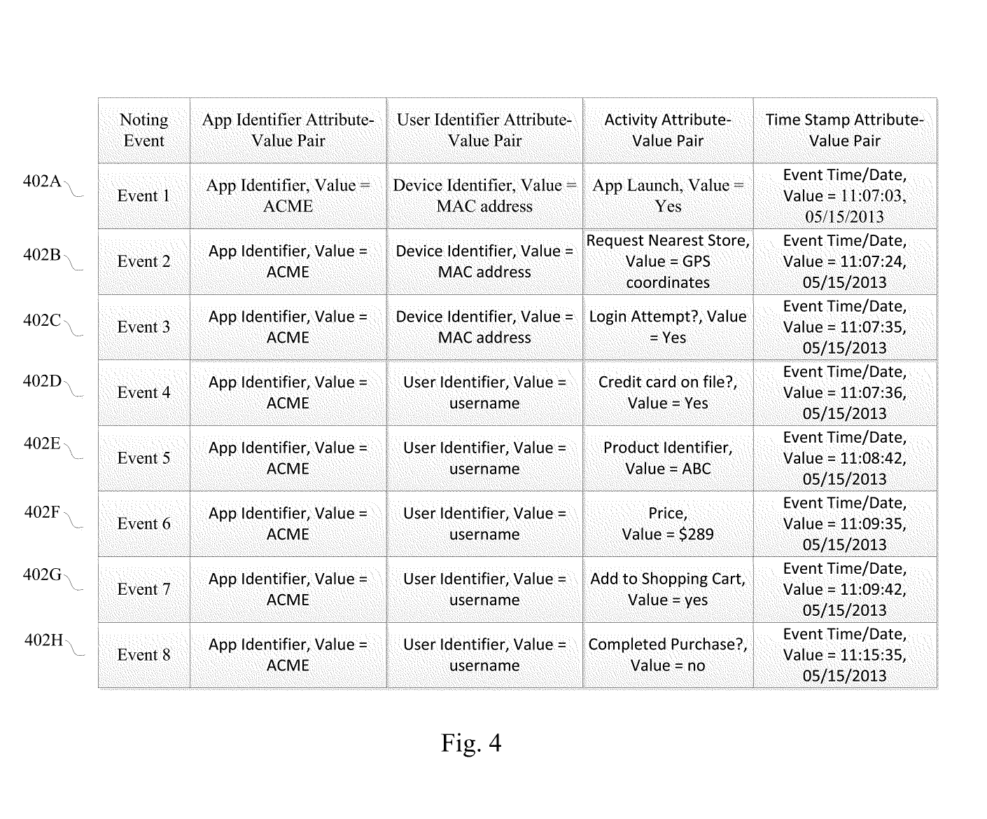

The client device 108 may record event data as the user interacts with the app 110. FIGS. 3A-D illustrate example graphical displays resulting from a user initiating application functions using their client device, and FIG. 4 illustrates event data generated in response to the user initiated functions in accordance with example embodiments. In an example, event data 402 may include one or more attribute-value pairs. Any number of attribute-value pairs may be logged depending on a desired level of specificity.

With reference to display 302A of FIG. 3A, a user may, for example, launch app 110. Noting code 204 may log the launch event and store data associated with the event. For example, event data 402A (see FIG. 4) corresponds to data logged corresponding to a user launching app 110. Types of attributes that may be logged when an app is launched may include an application identifier and its value (e.g., identifier of app 110), a device identifier attribute and its value (e.g., MAC address), an activity attribute and its value (e.g., App Launch), and a time stamp attribute and its value. In another example, noting code 204 may log event data 402B indicating a current geo-location (e.g., using GPS, triangulation, and the like) of client device 108 when app 110 was launched.

Returning again to FIG. 3A, the user may initiate a store locator function of app 110. The client device 108 may communicate geo-location data to the resource server 104, which may reply with a listing of one or more stores that are closest to the current geo-location. Noting code 204 may generate event data 402B (see FIG. 4) indicating the device identifier, the activity (e.g., request nearest store), and at what time the user initiated the store locator function. Noting code 204 may log other types of data, including the distance to each store on the list, whether the user selected a particular store from the list, and the time at which each function was initiated.

With reference to display 302B (see FIG. 3B), a user may initiate a login function. The client device 108 may prompt the user to enter a username and password for authentication purposes. In one example, the username may be an Apple® identifier or other type of identifier unique to the user. Noting code 204 may generate event data 402C (see FIG. 4) indicating the device identifier, the activity (e.g., user attempted to login), and at what time the user initiated the login function. Noting code 204 may also generate event data 402D indicating whether the user has a credit card (or other payment account) on file. Other types of data that may be logged include, for example, how long after user opened the app 110 that the user initiated the login function, number of failed login attempts, whether the user was ultimately successful, the order of any functions the user initiated after successful a successful login, and the time at which each function was initiated.

With references to displays 302C-D (see FIGS. 3C-D), a user may initiate a browse function to search for and ultimately select to view a particular product. Viewing a product (i.e., the display of a particular product to a particular consumer based on his or her actions) may indicate a particular user's interests and provide understanding on what sorts of consumers may be interested in a given product. In an example, the app 110 may display one or more categories in response to the user initiating the browse function. For example, app 110 may have a backpacks category, a lunch kits category, a school supplies category, and an art tables category. The user may subsequently initiate the browse function one or more times to drill down to a subcategory within a particular category. For example, a user may select a backpacks category in display 302C and drill down to a particular backpack, as shown in display 302D.

Noting code 204 may generate event data 402E-F indicating which products the user viewed and attributes about those products. For example, event 402E may include a unique product identifier associated with a product viewed using app 110. Event data 402F may include a price of the viewed product. Other types of event data may include which categories and subcategories the user viewed, attributes of the viewed products (e.g., color, size, quantity, etc.), the time at which each product was viewed, and the like. Noting code 204 may generate event data 402G-H about whether a product was added to an electronic shopping cart, and whether a purchase was completed. Noting code 204 may determine that a product was not purchased if a predetermined amount of time expired or app 110 was closed with the user completing the purchase. Noting code 204 may forward the event data 402 to the streaming module 206.

Streaming module 206 may receive the event data 402 from one or more instances of the noting code 204A-C, and optionally may compress the event data. For example, streaming module 206 identify remove common information in different instances of the event data. For example, event data 402A-B share common attributes and may be combined into a non-redundant superset of the unique attribute, value pairs.

Streaming module 206 may periodically communicate one or more messages including event data 402 to analysis server 118 optionally via a secure connection. In an example, streaming module 206 may encode, compress, and send event data in one or more packets to analysis server 118. Event data messages may be communicated after expiration of a timer. In another example, streaming module 206 may only communicate event data 402 when client device 108 is not using its radio to send any other signals. In yet another example, streaming module 206 may only communicate event data messages when client device 108 is already using its radio to send other signals and may send event data 402, for example, before, after, or simultaneously when the radio is sending the other signals The event data messages may also include an application identifier to distinguish app 110 from client applications of other advertisers.

With reference to FIG. 1, analysis server 118 may process received event data messages to passively generate at least a partial product catalog of the advertiser's products in database 122 and to gather information about the user. In some examples, analysis server 118 may decompress any compressed event data messages. The passively collected product catalog may not include information on all products in the advertiser's entire product catalog, and instead may advantageously only include a subset of the products that at least one customer has actually viewed using the app 110. For example, passive product catalog database 122 may only contain a subset of the data in product catalog database 102. In other words, analysis server 118 may passively collect and assemble event data 402 into at least a partial replica of the advertiser's product catalog.

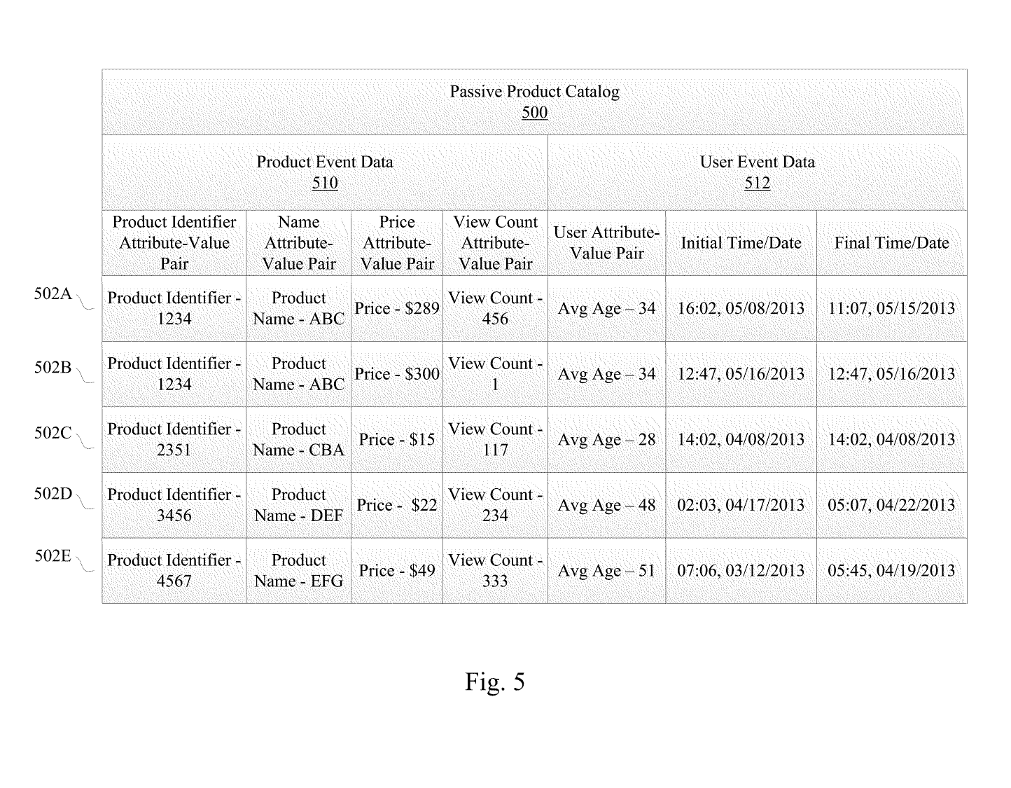

FIG. 5 illustrates an example of a passively collected product catalog (“passive product catalog”) in accordance with example embodiments. Passive product catalog 500 may include product profiles 502 storing attribute-value pairs containing event data on the product and event data on users who viewed and/or purchased the product. Product event data 510 may include attributes of the product, whereas user event data 512 may include attributes of users who viewed and/or purchased that product. In an example, a product profile 502 may include a product identifier, one or more product attribute-value pairs, initial and final times when the attribute-value pairs remained the same for that product, and one or more user attribute-value pairs. A product identifier may be, for example, a stock-keeping unit, an AMAZON® product code, and the like of a product available for purchase via the app 110. Examples of product attribute-value pairs include product name and its value, product price and its value, product color and its value, product size and its value, product profit margin and its value, and the like. Examples of user attribute-value pairs include user age and its value, zip code(s) (or other geographic regions) of users who view/purchase the product and its value(s), categories of users who view/purchase the product and its value(s), other products purchased by users who viewed/purchased the product and its value(s), and the like. The values of the user attribute-value pairs may be aggregated (e.g., average age, most popular zip codes, and the like).

When event data 402 is received, analysis server 118 may extract the application identifier to identify a passive product catalog 500 in database 122 associated with a particular advertiser and may extract the product identifier to determine whether a product profile 502 in the passive product catalog 500 already exists for that product identifier. If no product profile exists, analysis server 118 may create an entry for a new product profile that includes the product identifier, any received attribute-value pairs for that product, and any received attribute-value pairs of users who viewed and/or purchased that product. For newly created entries, the initial time/date and the final date/time may be the same (e.g., the time indicated by the time stamp for the received event data).

If there is an existing entry, analysis server 118 may distinguish between product event data 510 and user event data 512. For the existing entry, analysis server 118 determine whether the received product event data matches the product event data 510 already stored in the passive product catalog 500 (e.g., a received price matches a stored price). If it matches, analysis server 118 may update the final time/date field to include the time stamp. Thus the initial and final time/date, in combination, provide a time range over which the product event data 512 was the same. Any redundant product event data is not added to the product profile. This process of only updating the final time/date field, but not storing the redundant information, may be referred to as de-duplication. To monitor how many times a particular product has been viewed, analysis server 118 may update a product view count. Analysis server 118 may also update the user event data based on any user characteristics received in the event data message. Examples of user characteristics include demographic and geographic data about the user. User event data may also store information on ad impressions and click information. For example, user event data may indicate whether a particular advertisement was presented to a user, whether the user clicked on the advertisement, and whether the user ultimately made a purchase. Such data may also be aggregated and segmented based on demographic and geographic characteristics of the users. For example, analysis server 118 may determine a total number of times a group of users clicked on an advertisement and a total number of resulting purchases. The totals may be divided by age group (e.g., total number of 20-30 year olds who viewed the ad) or geographic region (e.g., total number of purchases in a particular zip code).

If the received product event data does not match the product event data 510 stored in the passive product catalog 500, analysis server 118 may create a new product profile to include the new event data. Product profiles 502A-B provide an example where a price for a product changed between profile 502A and profile 502B. As can be seen, product profiles 502A-B include a common product identifier “xx-1234” and product name “ABC.” Product profile 502A, however, lists a price of $289 whereas product profile 502B lists a price of $300. The initial and final time/date information lists the time period when each price was listed by the app 110.

Passive product catalog 500 may thus be a copy of a portion of the advertiser's product catalog database 102, that is passively collected based on event data received from users of the advertiser's app 110. Instead of requiring the advertiser to send its entire product catalog to the promoter, advantageously the users of the advertiser's app 110 send event data to the promoter to create the passive product catalog 500. In some examples, a promoter may work with multiple advertisers at the same time. The analysis server 118 may create a separate passive product catalog for each of the advertisers so that one promoter can service multiple advertisers at the same time without intermingling their data.

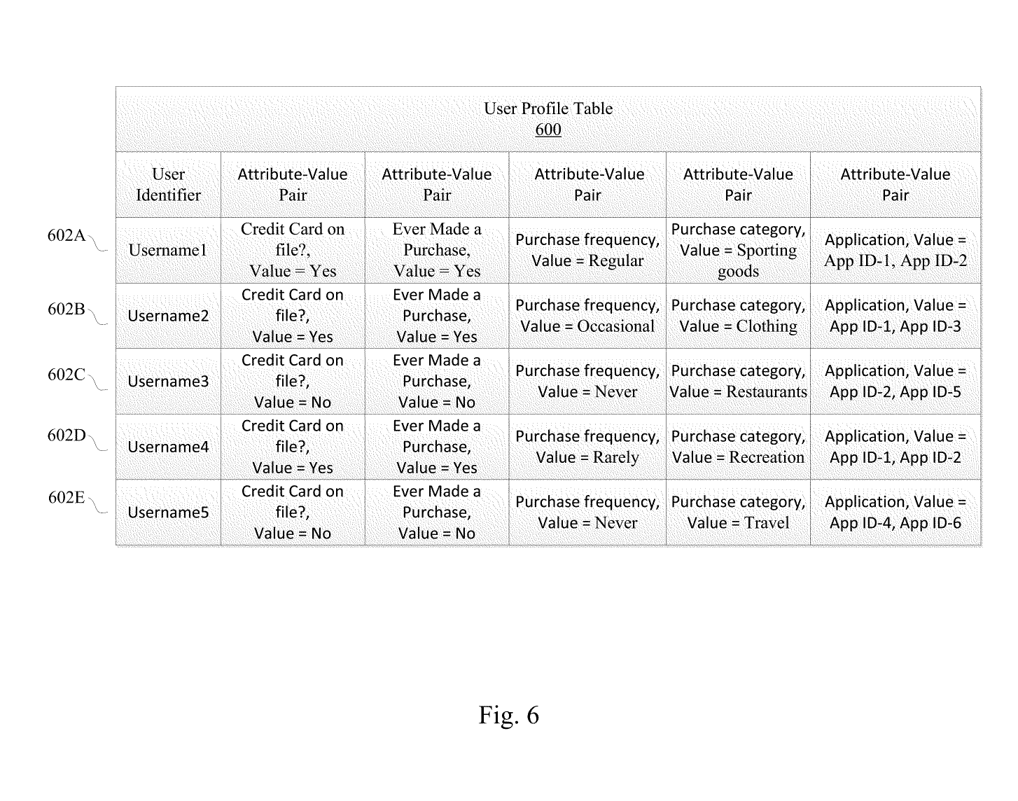

In addition to creating a passive product catalog, analysis server 118 may generate user profiles based on the received event data messages. The user profiles may be used by the advertisers, or other parties, for marketing to the users. In an example with reference to FIGS. 2 and 6, analysis server 118 may process the event data 402 to create and store in user profile database 208 a user profile table 600 storing a user profile 602 on each user who uses the app 110. Each user profile may also be based on event data received from one or more other apps. A user profile 602 may be used to market to a user and to identify trends for an individual user and for groups of users.

In an example, the promoter may use the profiles to identify which products are popular for algorithmically distributing advertisements to the user and other users. When an event data message is received, analysis server 118 may extract a user identifier and determine whether a user profile exists for that user. If not, analysis server 118 may create a user profile in table 600 including that user identifier. Once created or if there is an existing profile, analysis server 118 may update the user's profile with the received event data. Similar to the description above, analysis server 118 may not store any duplicate data in the user profile.

In an example, the user profile 602 may store the user identifier (e.g., username), whether the user has ever made a purchase using the app 110, whether the user has a credit card on file, how frequently the user makes purchases, categories in which the user makes purchases, profit margins of products purchased by the user (e.g., high margin, low margin, etc.), what apps the user uses, and the like. Other types of data that may be stored include what products the user viewed, purchases made, purchase frequency, average number of views before making a product, how frequently the user responds to an advertisement displayed by the app 110, and the like.

Analysis server 118 may also update the user profiles 602 to store user data retrieved from other sources. For example, an advertiser may have insight into its users such as whether a user has a credit card on file, user demographic information (e.g., age, gender, etc.), whether the user is a repeat purchaser, and the like. Resource server 202, for example, may be a source of such information to assist analysis server 118 in more effectively targeting an offer to a user.

Analysis server 118 may use the user profiles to provide a retargeting platform for, in some examples, targeting and tailoring of advertisements to users of app 110. The retargeting platform may be of interest to developers of ecommerce advertisers and subscription-based mobile apps, among others. The example embodiments may provide a retargeting solution that identifies users, monitors products previously displayed to each user, displays ads to users featuring previously viewed products, and tracks user purchases. The example embodiments may attribute purchases to the retargeted advertising when a user views, clicks, or otherwise interacts with an advertisement before purchase.

In an example, analysis server 118 may include a targeting engine 212 for targeting product offers to a user based on their user profile and the data stored therein. In some instances, a user may view a product using the app 110, and be interrupted before completing a purchase. The user may use their client device 108 to launch the app 110 at a later time or launch a different app (e.g., web browser, other app, etc.). The below discussion references a different app, but may equally apply to app 110. The different app, when launched, may communicate the user identifier of the user, and optionally the current geographic location of the client device 108, to the targeting engine 212 and request an advertisement.

Targeting engine 212 may process the user identifier to retrieve the associated user profile 602 to select one or more advertisements for presentation in the different app. Targeting engine 212 may also categorize the user into a group of similar users and send advertisements for products the similar users have purchased. In another example, targeting engine 212 may select advertisements based on what a user has already bought (e.g., people who buy product X also bought product Y). Targeting engine 212 may also serve a sequence of advertisements in an order that together tell a story or present a message, where the targeting engine 212 tracks which advertisement was previously sent and sends the next advertisement in the sequence.

In one example, targeting engine 212 may process the user profile 602 to determine that the user viewed a product using app 110, moved the product to an electronic shopping cart, but ultimately did not purchase the product. Targeting engine 212 may generate an advertisement including an image of the previously viewed, but unpurchased product. There also may be a threshold requirement to include that product in the advertisement (e.g., the user viewed that product on at least three previous occasions but did not purchase the product).

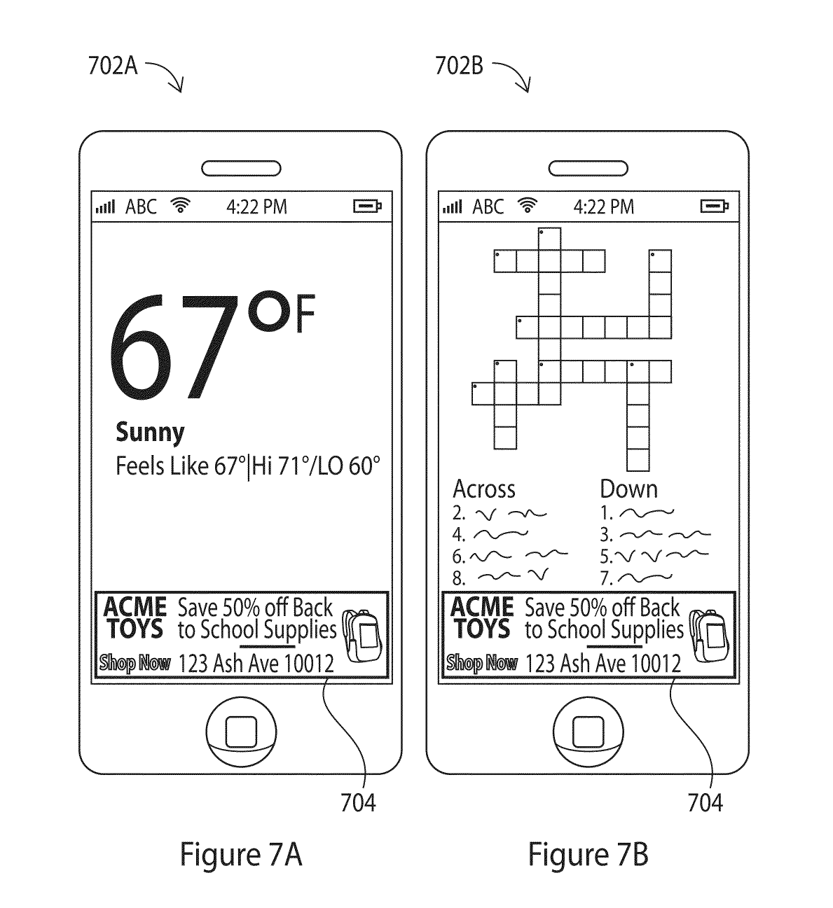

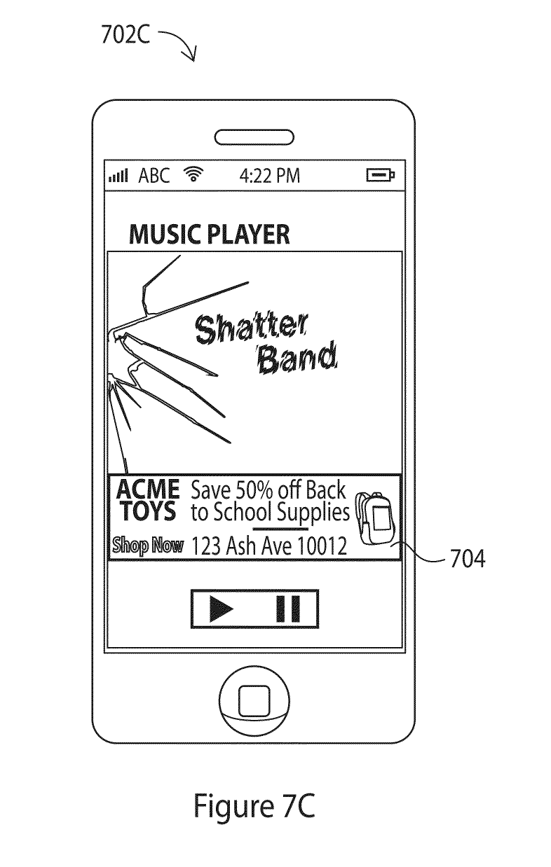

FIGS. 7A-C illustrate examples of a displayed advertisement for a previously viewed, but unpurchased product in accordance with example embodiments. In display 702A, client device 108 may present a banner advertisement including an image 704 of the previously viewed, but unpurchased product. As can been seen, an image of the backpack in display 302D is included in the banner advertisement image 704A. Displays 702B-C are examples images 704B-C of different backpack styles.

The user profile may be device-agnostic permitting sending of advertisements to the user regardless of device used. For instance, a user may use their user identifier on multiple devices, and the targeting engine 212 may look-up the user's profile using the user identifier. Thus, the user may receive a consistent experience across devices because the targeting engine 212 can use the same user profile.

In other examples, targeting engine 212 may identify an advertisement for a similar or related product. For instance, a similar product may be a different style of backpack, and a related product may be back to school supplies. For example, the user profile may indicate that a user viewed five similar styles of shirts available from an advertiser, but did not make a purchase. Targeting engine 212 may process the passive product catalog database 122 to determine if there are any other similarly styled shirts that the user has not viewed and may send an advertisement including an image of the most popular similarly styled shirts determined based on number of views by other users. Popularity may be based on, for example, the product view count stored in the passive product catalog 500. Similarity may be based on product types a user typically buys (e.g., high end, low profit margin, and the like).

In other examples, targeting engine 212 may retrieve inventory availability information from resource server 202 prior to sending out an advertisement. For example, targeting engine 212 may determine how long a product is available and whether sold out to avoid promoting unavailable products. If availability is limited or a product is unavailable, targeting engine 212 may instead search for and identify similar products from the passive product catalog database 122 to promote that users may also like. A further benefit of this approach is that the promoter has continuous access to new product information as soon as consumers do via the event data messages, meaning that the promoter can react to changes in inventory levels more quickly than a promoter relying on a daily or semi-daily feed.

In further examples, targeting engine 212 may process the user profile to identify any product or service subscriptions that the user has signed up for, and an expiration date of the subscription. For example, a user may sign up for an online magazine accessible through the app 110. Targeting engine 212 may determine when the subscription expires, and select an advertisement attempting to reengage the user with the subscribed product so that the user desires to renew the subscription prior to expiration.

In another example, targeting engine 212 may select an advertisement based on a user's current geographic location and on their user profile. For instance, targeting engine 212 may periodically receive the user's current geographic location in the event data. When the user is within a predetermined distance of an advertiser's store, targeting engine 212 may process the user's profile to select the advertiser's advertisement. When a user uses apps of multiple advertisers, targeting engine 212 may determine a proximity of the user to each advertiser's nearest store location, and select an advertisement for the advertiser having the closest store location. Advertiser's may also pay differing amounts for certain users within a certain radius of their stores and the targeting engine 212 may server advertisements based on a highest payment amount rather than, or in addition to, geographic proximity.

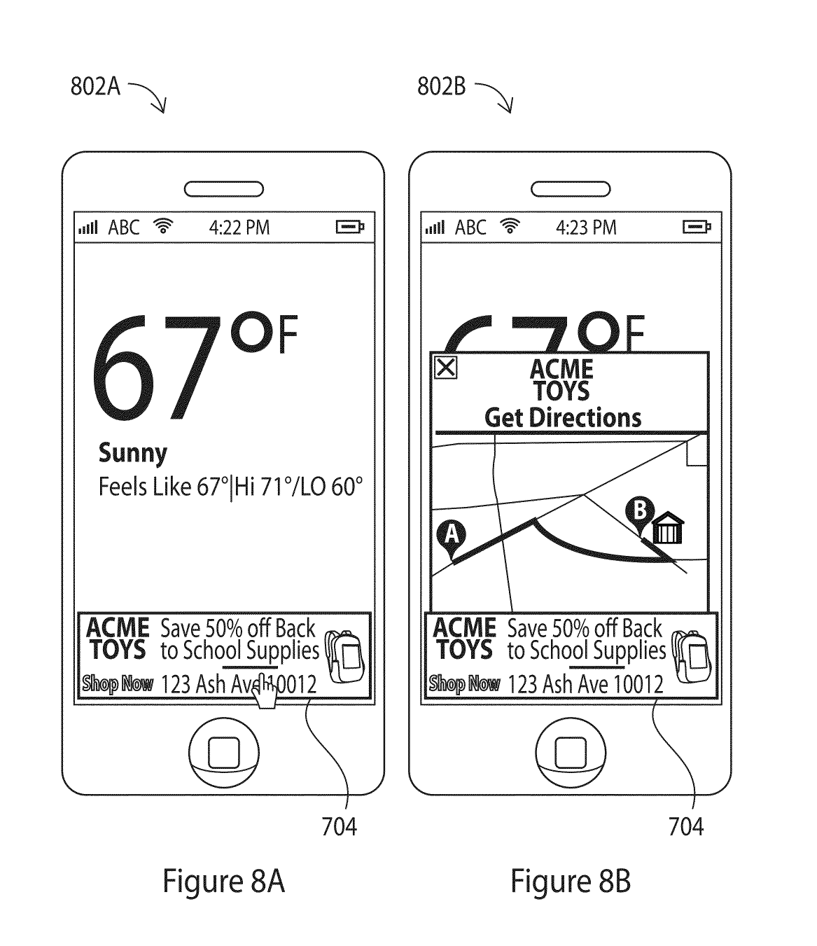

In another example, the advertisement may include directions from the user's current geographic location to the advertiser's nearest store. FIGS. 8-B illustrate an example of a displaying an advertisement based on a user's current geographic location in accordance with example embodiments. In an example, display 802A may include an advertisement 804 including an image of the previously viewed, but unpurchased product and may include an address of the advertiser's nearest store location. Upon selection of advertisement 804, a window may appear to display directions from the user's current geographic location and the advertiser's nearest store location.

In another example, analysis server 118 may provide reports to advertisers at periodic time periods or in response to advertiser's requests. In some examples, the reports may provide feedback based on the popularity of the advertiser's offered products. For instance, the reports may indicate what products users of their app 110 have viewed and metrics on how popular a particular product is. For example, popularity metrics may indicate a total number of times each user viewed a particular product and a total number of times a particular product was viewed by any user. Popularity data may also have demographic and/or geographic components (e.g., total number of views of Alaskan female users between the ages of 18-34). Popularity data may indicate which products have been viewed less than a predetermined number of times. Analysis server 118 may communicate the popularity data to the resource server 202 to enable the advertiser to make decisions about which products to offer.

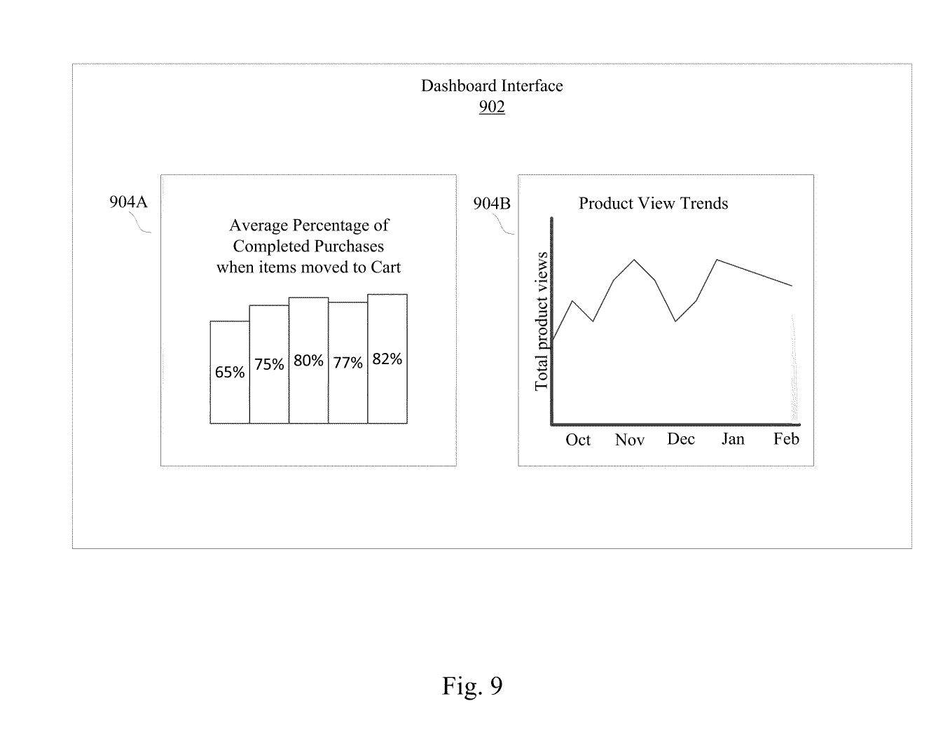

Analysis server 118 may also provide a dashboard interface permitting advertisers to access metrics based on the event data. FIG. 9 illustrates an example of a dashboard interface in accordance with example embodiments. In an example, dashboard interface 902 may be a website available via network 70 accessible to personnel of an advertiser. As depicted, interface 902 may present one or more charts 904A-B generated based on the user behavior data to provide feedback to an advertiser based on offered products.

The dashboard interface 904 may permit users to select date ranges for reports with a default period of current day, preset options for yesterday, last 7 days, month to date, all time, and a custom date range. The reports can be broken out at vertical, advertiser, campaign and publisher levels (e.g., Vertical_id, Advertiser_org_id, campaign_id and publisher_org_id).

In an example, dashboard interface 902 may prompt an advertiser user to log in and may present a “welcome” screen when he or she successfully logs in. The welcome screen may present charts with trends, display any alerts that have been triggered (these alerts may also be sent immediately via email or other communication framework), the time period used in displayed charts, and any filters that have been applied to the displayed data. For example, a trend may be based on changes over time to a ratio of how often a user views a product or service relative to how often the user purchases the product or service. Another trend may be on average number of functions the user initiates prior to making a purchase.

An advertiser may filter displayed charts by one or more fields (e.g., Vertical_id, Advertiser_org_id, campaign_id and publisher_org_id), and may have the option to select multiple items in each category (e.g., two out of four campaigns can be selected for a given advertiser). When a selection is made, the dashboard interface 902 may calculate metrics and update one or more charts to reflect the change. The advertiser may also use a date range selector that will also apply any changes to all dashboard data.

To proceed to an advertiser specific section of the dashboard interface, the advertiser may select a specific advertiser by either (1) typing an advertiser name into a text search box that filters the list of available advertisers by letter for selection of a particular advertiser name; or (2) selecting the advertiser's name from a dropdown filter menu that pre-populates a search box with the advertiser's name. If an advertiser filters the charts to a specific campaign, then the charts 604 may update to that campaign and a search box may display the advertiser of that campaign.

The dashboard interface 902 may provide two basic forms of user permissions: access and ability. Access may determine which specific advertiser accounts a given user will be able to access. Ability may determine read/write status, whether users can simply view the charts and data, and whether they can create new items and make adjustments. Advertiser users with access permission may be allowed to progress to the advertiser specific section without selecting a particular advertiser name to view detailed reporting with all advertisers in aggregate.

In further examples, the dashboard interface 904 may graph metrics on: cost, gross revenue, net revenue (gross revenue-cost) and margin (1−(cost/gross revenue)), with totals for specified date ranges and daily trends for specified date ranges. The dashboard interface may provide a graph for conversions, effective cost per acquisition (eCPA) with totals for specified date ranges and daily trends for specified date ranges to indicate whether the eCPA is trending better or worse, and return on ad spend (ROAS). The dashboard interface 904 may show percentage change in eCPA by advertiser on the Gantt chart and allow sorting of publishers by percentage change for identifying the highest/lowest in each category.

The dashboard interface 904 may indicate which networks are currently live for a campaign, which networks are going live, and which networks have been paused, as well as what dates each event happened and how long each network was in each state (e.g., a modified Gantt chart). The dashboard interface 904 may also include a Gantt chart showing the status of each advertiser at the filtered level. The dashboard interface may adjust the x axis data range of the Gantt chart in coordination with all other charts on the page.

The dashboard interface may provide for data priority. For example, data on a live campaign may trump data on a paused campaign and a launching campaign, and data on a launching campaign may trump data on a launching paused if the advertisers have different statuses for a specified view. The dashboard interface 904 may include bar denoting cost volume for each publisher in view.

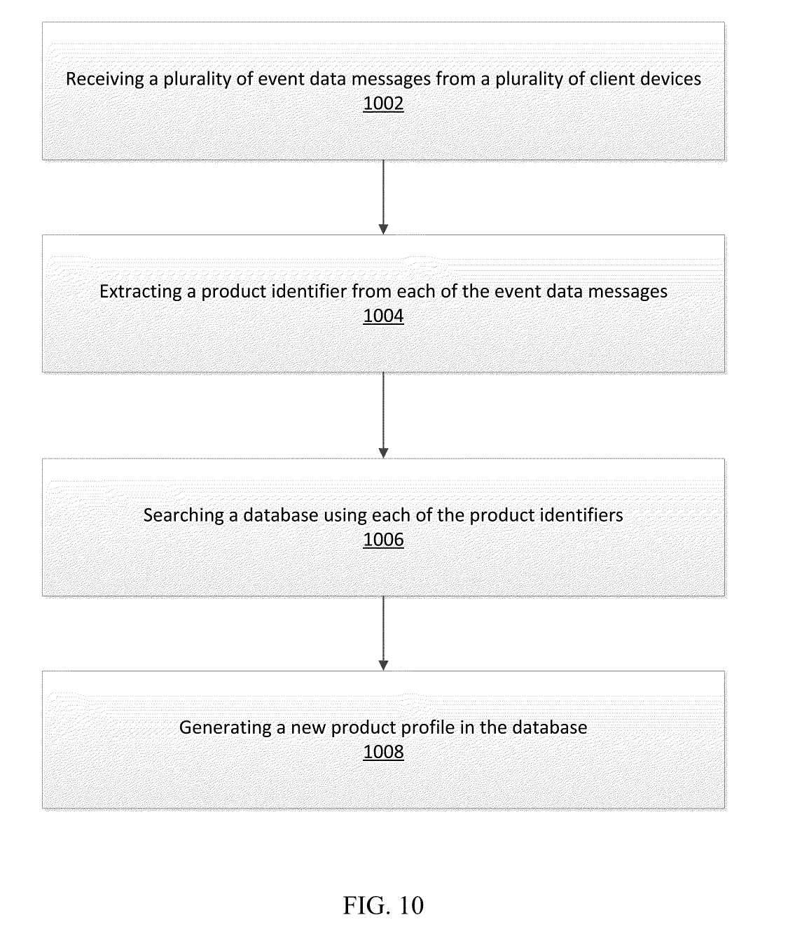

FIG. 10 illustrates a flow chart of a method for advertisement retargeting in accordance with example embodiments. The flow diagram may be implemented by a system or apparatus, such as, for example, analysis server 118. Each of the blocks shown in the flow diagram may be repeated one or more times, one or more of the blocks may be modified, and one or more of the blocks may be omitted. The method may be stored on a non-transitory computer readable medium as computer executable instructions. The computer executable instructions, when executed by at least one processor, may cause at least one computer or other device to perform the blocks as steps of a method one or more times. The flow diagram may begin at block 1002.

In block 1002, the method may include receiving a plurality of event data messages from a plurality of client devices, wherein the event data messages are generated in response to a user of each of the client devices utilizing the application, wherein the application is associated with an advertiser having a product catalog of products available for purchase via the application. In block 1004, the method may include extracting a product identifier from each of the event data messages, wherein each of the product identifiers is associated with a product available for purchase via the application. In block 1006, the method may include searching a database using each of the product identifiers to determine whether an existing product profile has been created for the corresponding product identifier. In block 1008, the method may include generating a new product profile in the database and populating at least one attribute field in the new product profile with information derived from the event data, for each of the product identifiers for which no existing product profile had been created, wherein the database stores the existing and new product profiles as a second product catalog that comprises at least a subset of the product catalog of the advertiser. The method may end, may return to any of the preceding steps, and may repeat one or more times.

In some examples, analysis server 118 may comply with goals of the advertisers and meet user privacy needs. For instance, analysis server 118 may not collect personally identifiable information or intermingle a particular user's data with anyone else's. Further, the analysis server 118 and noting code 204 may respect each users' privacy settings, their network bandwidth, and battery life. Thus, the example embodiments may minimally burden advertisers and its users. Moreover, the advertiser's software engineers do not have to shift their focus from creating great customer experiences to push product feeds to the analysis server 118.

With reference again to FIG. 1, networks 70 are shown interconnecting various components. Networks 70 may be the Internet, WAN, LAN, Wi-Fi, other computer networks (now known or invented in the future), and/or any combination of the foregoing. It should be understood by those of ordinary skill in the art having the present specification, drawings, and claims before them that networks 70 may connect the various components over any combination of wired and wireless conduits, including copper, fiber optic, microwaves, and other forms of radio frequency, electrical and/or optical communication techniques. It should also be understood that any network 70 may be connected to any other network 70 in a different manner. The interconnections between devices in FIG. 1 are examples and not limitations. Any device depicted in FIG. 1 may communicate with any other device via one or more of the networks 70.

The system depicted in FIG. 1 can be utilized with a variety of different client devices 108, including but not limited to PDA's, cellular phones, smart phones, laptops, tablet computers, and other mobile devices that preferably include cellular voice and data service as well as preferably access to consumer downloadable applications. One such client device could be an iPhone, Motorola RAZR or DROID; however, the present disclosure is preferably platform and device independent. For example, a client device technology platform may be Microsoft Windows Mobile, Microsoft Windows Phone 7, Palm OS, RIM Blackberry OS, Apple OS, Android OS, Symbian, Java or any other technology platform. For purposes of this disclosure, the present disclosure has been generally described in accordance with features and interfaces that are optimized for a smart phone utilizing a generalized platform, although one skilled in the art would understand that all such features and interfaces may also be used and adapted for any other platform and/or device.

Client Devices 108A-D may be general purpose computers having, among other elements, a microprocessor (such as from the Intel Corporation or AMD); volatile and non-volatile memory; one or more mass storage devices (i.e., a hard drive, RAM, ROM, etc.); one or more removable memory cards, various user input devices, such as a mouse, a keyboard, or a microphone; and a video display system. The mass memory provides storage for computer readable instructions and other data, including a basic input/output system (“BIOS”) and an operating system for controlling the operation of the portable communication device. In one aspect, the general-purpose computer may be controlled by the WINDOWS XP® operating system. It is contemplated, however, that the present system would work equally well using a MACINTOSH computer or even another operating system such as a WINDOWS VISTA, UNIX, LINUX or a JAVA based operating system, to name a few.

Client Devices 108A-D may include a mobile network interface to establish and manage wireless communications with a mobile network operator. The mobile network interface uses one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the mobile network of a mobile network operator. Accordingly, the mobile network interface may include as a transceiver, transceiving device, or network interface card (NIC). It is contemplated that the mobile network interface and short proximity electromagnetic communication device could share a transceiver or transceiving device, as would be understood in the art by those having the present specification, figures, and claims before them.

Client Devices 108A-D may include a location transceiver that can determine its physical coordinates on the Earth's surface typically as a function of its latitude, longitude and altitude. This location transceiver preferably uses GPS technology, so it may be referred to herein as a GPS transceiver; however, it should be understood that the location transceiver can additionally (or alternatively) employ other geo-positioning mechanisms, including, but not limited to, triangulation, assisted GPS (AGPS), E-OTD, CI, SAI, ETA, BSS or the like, to determine its physical location on the Earth's surface.

Client Devices 108A-D may further include a user interface that provides some means for the user to receive information as well as to input information or otherwise respond to the received information. As is presently understood (without intending to limit the present disclosure thereto) this user interface may include a microphone, an audio speaker, a haptic interface, a graphical display, and a keypad, keyboard, pointing device and/or touch screen.

Client Devices 108A-D may also include a device identification memory dedicated to identify the device, such as a SIM card. As is generally understood, SIM cards contain the unique serial number of the device (ESN), an internationally unique number of the mobile user (IMSI), security authentication and ciphering information, temporary information related to the local network, a list of the services the user has access to and two passwords (PIN for usual use and PUK for unlocking). As would be understood in the art by those having the present specification, figures, and claims before them, other information may be maintained in the device identification memory depending upon the type of device, its primary network type, home mobile network operator, etc.

Client Devices 108A-D may operably connect to servers 104 and 118, via one of many available internet browsers including, but not limited to, Microsoft's Internet Explorer, Apple's Safari, and Mozilla's Firefox. Via any of networks 70, end users may access servers 104 and 118 with an http-based website, although other graphical user interfaces can be used with the present system.

Servers 104 and 108 may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. Servers 104 and 108 may be running on any one of many operating systems including, but not limited to WINDOWS, UNIX, LINUX, MAC OS, or Windows (XP, VISTA, etc.). It is contemplated, however, that any suitable operating system may be used for the present disclosure. Servers 104 and 108 may be a cluster of web servers, which may each be LINUX based and supported by a load balancer that decides which of the cluster of web servers should process a request based upon the current request-load of the available server(s). The servers may be in multiple locations but may act together as a single server such as in a cloud based computing system.

Servers 104 and 108 may perform functions in serial or in parallel on the same computer or across a local or wide area network distributed on a plurality of computers, where the computer may be controlled by the Linux operating system. It is contemplated, however, that the system would work equally well using a Macintosh® operating system or even another operating system such as Windows®, Windows CE, Unix, or a Java® based operating system, to name a few. Some details of a preferred servers 104 and 108 are shown in FIG. 1 with it being understood that any server has further aspects not shown to avoid obscuring the example embodiments.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example and not limitation, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present disclosure as described above can be implemented in the form of control logic using computer software in a modular or integrated manner. Based on the disclosure and teachings provided herein, a person of ordinary skill in the art may know and appreciate other ways and/or methods to implement the present disclosure using hardware, software, or a combination of hardware and software.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

Methods or processes in accordance with the various embodiments of the disclosure may be implemented by computer readable instructions stored in any media that is readable and executable by a computer system. A machine-readable medium having stored thereon instructions, which when executed by a set of processors, may cause the set of processors to perform the methods of the disclosure. A machine-readable medium may include any mechanism for storing or transmitting information in a form readable by a machine (e.g., a computer). A machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.).

While various embodiments of the present disclosure have been described above, it should be understood that such disclosures have been presented by way of example only, and are not limiting. Thus, the breadth and scope of the present disclosure should not be limited by any of the above-described exemplary embodiments, but should be defined only in accordance with the following claims and their equivalents. While the specification is described in relation to certain implementations or embodiments, many details are set forth for the purpose of illustration. Thus, the foregoing merely illustrates the principles of the disclosure, and the disclosure is not limited thereto. For example, the disclosure may have other specific forms without departing from its spirit or essential characteristic. The described arrangements are illustrative and not restrictive. To those skilled in the art, it will be clear that the disclosure is susceptible to additional implementations or embodiments and certain of these details described in this application may be varied considerably without departing from the basic principles of the disclosure. It will thus be appreciated that those skilled in the art will be able to devise various arrangements which, although not explicitly described or shown herein, embody the principles of the disclosure and, thus, within its scope and spirit.

1. A system for harnessing user behavior associated with an application, the system comprising:
means for receiving a plurality of event data messages from a plurality of client devices, wherein the event data messages are generated in response to a user of each of the client devices utilizing the application, wherein the application is associated with an advertiser having a product catalog of products available for purchase via the application;
means for extracting a product identifier from each of the event data messages, wherein each of the product identifiers is associated with a product available for purchase via the application;
means for searching a database using each of the product identifiers to determine whether an existing product profile has been created for the corresponding product identifier;
means for generating a new product profile in the database and populating at least one attribute field in the new product profile with information derived from a corresponding event data message, for each of the product identifiers for which no existing product profile has been created, wherein the database stores the existing and new product profiles as a second product catalog that comprises at least a subset of the product catalog of the advertiser.

2. The system of claim 1, further comprising means for aggregating data from product profiles in the database and for communicating a report to the advertiser based on the aggregated data.

3. The system of claim 1, further comprising:
means for receiving an advertisement request from a particular one of the client devices, wherein the advertisement request comprises a user identifier;
means for identifying a user profile associated with the user identifier;
means for selecting an advertisement based on the user profile; and
means for communicating the selected advertisement to the particular client device for presentation to the user.

4. The system of claim 3, wherein the means for selecting the advertisement comprises means for processing the user profile to identify a particular product that was previously viewed, but not purchased, wherein the selected advertisement comprises an advertisement for the particular product.

5. The system of claim 3, further comprising:
means for determining a geographic location of the particular client device;
wherein the means for selecting the advertisement comprises means for identifying a geographic location of a physical store of the advertiser based on proximity to the geographic location of the particular client device, and
wherein the selected advertisement identifies the geographic location of the physical store.

6. The system of claim 5, wherein the selected advertisement comprises a map providing directions from the geographic location of the particular client device to the geographic location of the physical store.

7. The system of claim 1, further comprising:
means for noting event data from user behavior associated with interaction with the application; and
a streaming means for compressing the event data and for periodically streaming the compressed event data.

8. A method for harnessing user behavior associated with an application, the method comprising:
receiving a plurality of event data messages from a plurality of client devices, wherein the event data messages are generated in response to a user of each of the client devices utilizing the application, wherein the application is associated with an advertiser having a product catalog of products available for purchase via the application;
extracting a product identifier from each of the event data messages, wherein each of the product identifiers is associated with a product available for purchase via the application;
searching a database using each of the product identifiers to determine whether an existing product profile has been created for the corresponding product identifier;
generating a new product profile in the database and populating at least one attribute field in the new product profile with information derived from a corresponding event data message, for each of the product identifiers for which no existing product profile has been created, wherein the database stores the existing and new product profiles as a second product catalog that comprises at least a subset of the product catalog of the advertiser.

9. The method of claim 8, further comprising aggregating data from product profiles in the database and for communicating a report to the advertiser based on the aggregated data.

10. The method of claim 8, further comprising:
receiving an advertisement request from a particular one of the client devices, wherein the advertisement request comprises a user identifier;
identifying a user profile associated with the user identifier;
selecting an advertisement based on the user profile; and
communicating the selected advertisement to the particular client device for presentation to the user.

11. The method of claim 10, wherein the selecting the advertisement comprises processing the user profile to identify a particular product that was previously viewed, but not purchased, wherein the selected advertisement comprises an advertisement for the particular product.

12. The method of claim 10, further comprising:
determining a geographic location of the particular client device;
wherein the selecting the advertisement comprises identifying a geographic location of a physical store of the advertiser based on proximity to the geographic location of the particular client device, and
wherein the selected advertisement identifies the geographic location of the physical store.

13. The method of claim 12, wherein the selected advertisement comprises a map providing directions from the geographic location of the particular client device to the geographic location of the physical store.

14. The method of claim 8, further comprising:
noting event data from user behavior associated with interaction with the application; and
compressing the event data and for periodically streaming the compressed event data.

15. A computer readable medium storing instructions for harnessing user behavior associated with an application, the instructions, when executed by an apparatus, cause the apparatus at least to perform:
receiving a plurality of event data messages from a plurality of client devices, wherein the event data messages are generated in response to a user of each of the client devices utilizing the application, wherein the application is associated with an advertiser having a product catalog of products available for purchase via the application;
extracting a product identifier from each of the event data messages, wherein each of the product identifiers is associated with a product available for purchase via the application;
searching a database using each of the product identifiers to determine whether an existing product profile has been created for the corresponding product identifier;
generating a new product profile in the database and populating at least one attribute field in the new product profile with information derived from a corresponding event data message, for each of the product identifiers for which no existing product profile has been created, wherein the database stores the existing and new product profiles as a second product catalog that comprises at least a subset of the product catalog of the advertiser.

16. The computer readable medium of claim 15, wherein the instructions, when executed, cause the apparatus at least to perform aggregating data from product profiles in the database and for communicating a report to the advertiser based on the aggregated data.

17. The computer readable medium of claim 15, wherein the instructions, when executed, cause the apparatus at least to perform:
receiving an advertisement request from a particular one of the client devices, wherein the advertisement request comprises a user identifier;
identifying a user profile associated with the user identifier;
selecting an advertisement based on the user profile; and
communicating the selected advertisement to the particular client device for presentation to the user.

18. The computer readable medium of claim 17, wherein the selecting the advertisement comprises processing the user profile to identify a particular product that was previously viewed, but not purchased, wherein the selected advertisement comprises an advertisement for the particular product.

19. The computer readable medium of claim 17, wherein the instructions, when executed, cause the apparatus at least to perform:
determining a geographic location of the particular client device;
wherein the selecting the advertisement comprises identifying a geographic location of a physical store of the advertiser based on proximity to the geographic location of the particular client device, and
wherein the selected advertisement identifies the geographic location of the physical store.

20. The computer readable medium of claim 19, wherein the selected advertisement comprises a map providing directions from the geographic location of the particular client device to the geographic location of the physical store.
